(19) United States
(12) Patent Application Publication
(10) Pub. No.: US 2010/0138285 A1
(43) Pub. Date: Jun. 3, 2010

(54) SYSTEMS AND METHODS FOR ADVERTISEMENT SERVING NETWORKS

(75) Inventors: Michael Leonard, Alpharetta, GA (US); Hunter Randall Spence, Atlanta, GA (US); Graham Engebretsen, Atlanta, GA (US)

Correspondence Address: ROPES & GRAY LLP, PATENT DOCKETING 39/41, ONE INTERNATIONAL PLACE, BOSTON, MA, 02110-2624, US

(73) Assignee: Sapient Corporation, Boston, MA (US)

(21) Appl. No.: 12/630,653

(22) Filed: Dec. 3, 2009

Related U.S. Application Data
(60) Provisional application No. 61/200,778, filed on Dec. 3, 2008.

(51) Int. Cl. G06Q 30/00

(52) U.S. Cl. 705/14.5; 705/14.49

(57) ABSTRACT

A system and method for distributing media content via networked devices. A system includes at least one networked device configured to receive media content and business rules from a control server. The at least one networked device may be configured to select media content for display based at least in part on the business rules.

### REFERENCE TO RELATED APPLICATIONS

This application claims the benefit of and priority to U.S. Provisional Application No. 61/200,778, filed on Dec. 3, 2008, entitled “Kiosk Vending Networks,” the entire contents and teachings of which are incorporated herein by reference.

### FIELD OF THE INVENTION

The invention relates generally to methods and systems for serving advertisements. More particularly, in various embodiments, the invention relates to providing a system for networked advertisement serving devices.

### BACKGROUND

Recently, engineers have developed vending machines that include web servers to improve the ability of the vending machine to sell products to consumers. One such vending machine is described in PCT Patent publication WO/2002/019279, entitled “Vending System” and owned by Marconi Communications. The Marconi system sells products or services to purchasers by providing a vending machine that has a wireless internet connection. The vending machine allows a customer to communicate to an operator via the internet connection and allows the operator to authorize via the Internet connection an identified vending machine to make a sale to the purchaser and then notify the purchaser via the Internet connection. This can be done by allowing the customer to use their cell phone to buy products, thus freeing the customer from having to have the cash on hand to buy products sold from the vending machine.

Other vending machines include those described in US Patent Publication 2008/0230347, entitled Interactive Vending Machines and a Method of Operating Same. This publication describes a vending machine for multiple product sales, including means for displaying multiple products; means for operating the machine and effecting the dispensing of any selected product; at least one display screen disposed adjacent to the means for displaying multiple products, and an electronic control unit for selectively controlling the display on the screen prior to, and/or during, and/or after a vending operation. Additionally, these machines can include screen displays disposed that connect to an electronic control unit for selectively controlling the display, including the content on the display, prior to, and/or during, and/or, after a vending operation. This allows for advertisements to be presented to the consumer. Sensors may also be used to detect the presence of a person adjacent to the vending machine and to generate a signal when a person is detected, and activating the display to show an attention-attraction and/or sales-promotion video. Further the vending machine can include a multiplicity of general-nature sales-promotion video clips arranged for preprogrammed display on the screen.

Although such vending machine systems can enrich the user experience by presenting videos on interest and by facilitating the purchase of goods, there remains a need for systems that leverage more fully the ubiquity of vending machines.

### SUMMARY OF THE INVENTION

This application discloses various methods and systems that enable enhanced advertising and commerce. In particular, the systems and methods disclosed herein enable the distribution of media content via networked devices. These systems and methods enable business rules and/or media content to be loaded remotely, thereby providing a flexible advertisement serving platform. In addition, the business rules may include rules for displaying advertisements based at least in part on the location of the networked devices. Furthermore, the business rules may include rules for displaying advertisements based at least in part on time or an event.

In one aspect, a system for distributing media content includes a control server in communication with a data network. The control server includes media content and business rules associated with the use of the media content. The system also includes a first advertisement serving device in communication with the data network. The advertisement serving device includes a network interface configured to receive the media content and the business rules from the control server via the data network. The device includes a processor configured to select a first portion of the media content based at least in part on the business rules received from the control server. Further, the device includes a display that displays the first portion of selected media content. The system may include a second advertisement serving device in communication with the control server via the data network. An advertising serving device may include, without limitation, a vending device, a signage device, a commerce device, and/or marketing device. A signage device may include a menu board such as, without limitation, a listing of food items at a restaurant. The signage device may include a digital and/or electronic signage device.

In one configuration, the first portion of the media content includes an advertisement. The advertisement may be related to a product and/or service. In one feature, the business rules include rules for selecting the first portion of the media content for display based at least in part on the geographic location of the first advertisement serving device. The business rules may include rules for selecting the first portion of the media content based at least in part on a business located within proximity of the advertisement serving device. The business rules may also include rules for selecting the first portion of the media content based on the time of day, day in the week, day in the year, season, holidays, retail sales periods, and/or cultural events.

In another configuration, the advertisement serving device includes a printing component configured to provide printed media for a consumer. The printed media may include a ticket, a pass, a coupon, a voucher, a loyalty card, a text message, a photograph, an image, a token, a note of monetary value, a credit card, and/or a gift card.

In one feature, the network interface is configured to send usage data to the control server. The usage data may include usage information associated with the first advertisement serving device. In another feature, the first portion of selected media content is related to a product and/or service being dispensed via the advertisement serving device. Alternatively, the first portion of the media content may not be related to a product and/or service being dispensed via the advertisement serving device.

The advertisement serving device may include a user interface to conduct commerce and/or dispense a selected product to a consumer. The processor of the serving device may be configured to select a product based on the business rules received from the control server. Conducting commerce may include product vending, selling merchandise, selling tickets, dispensing money, conducting financial transactions, providing a service, and/or dispensing information. The user interface may include an interface component that receives a product selection from the consumer, a payment interface component that processes a payment from the consumer, and/or a dispensing component that dispenses the selected product to the consumer.

In another aspect, an advertisement serving device includes a network interface that receives targeted advertising rules and a set of advertising content from a control server via a communications network. The device includes a memory configured to store the targeted advertising rules and the set of advertising content. The device also includes a processor configured to select an advertisement from the set of advertising content in the memory based on the targeted advertising rules. Further, the device includes a display configured to display the selected advertisement.

In a further aspect, a distributed system of advertisement serving devices includes first and second advertisement serving devices. The first advertisement serving device may be configured to store business rules and a plurality of advertisements in an associated memory, select a first advertisement from the plurality of advertisements based at least in part on the business rules stored on the associated memory, and display the selected advertisement on a display screen of the first advertisement serving device.

The second advertisement serving device may be located in a different location from the first advertisement serving device. The second advertisement serving device may be configured to store business rules and a plurality of advertisements in its associated memory, select a second advertisement from the plurality of advertisements based at least in part on the business rules stored on the second memory, and display the selected advertisement on a display screen of a second advertisement serving device. The distributed system may use a control server configured to load media content and business rules onto the memory of the first advertisement serving device and the memory of the second advertisement serving device via a network.

The invention will now be described with reference to various illustrative embodiments.

### BRIEF DESCRIPTION OF THE DRAWINGS

The foregoing and other objects, features, advantages, and illustrative embodiments of the invention will now be described with reference to the following drawings in which like reference designations refer to the same parts throughout the different views. These drawings are not necessarily to scale, emphasis instead being placed upon illustrating principles of the invention.

FIG. 1 includes a network diagram of an advertisement serving system according to several illustrative embodiments of the invention.

FIG. 2 includes a functional block diagram of an advertisement serving device according to an illustrative embodiment of the invention.

FIG. 3 includes an architecture diagram of the advertisement serving system according to an illustrative embodiment of the invention.

FIG. 4 includes a set of media content design variations according to an illustrative embodiment of the invention.

FIG. 5 includes a wireframe of a commerce application according to an illustrative embodiment of the invention.

FIG. 6 includes another wireframe of a commerce application according to an illustrative embodiment of the invention.

FIG. 7 includes a set of media content according to an illustrative embodiment of the invention.

FIG. 8 includes a flow diagram of a method for distributing media content according to an illustrative embodiment of the invention.

FIG. 9 includes a flow diagram of a method for distributing media content according to another illustrative embodiment of the invention.

### DESCRIPTION OF ILLUSTRATIVE EMBODIMENTS

As described above in the summary, the invention is generally directed to systems and methods that provide a system and a solution framework for serving advertisements and facilitating commerce.

To provide an overall understanding of the invention, certain illustrative embodiments will now be described, including a system that provides a network of distributed advertisement serving machines, each being capable of serving media content. However, it will be understood by one of ordinary skill in the art that the systems and methods described herein can be adapted and modified for other suitable applications and that such other additions and modifications will not depart from the scope hereof. For purposes of simplicity, the system is described primarily in the context of advertising. However, the system may also be applicable to other kinds of commerce-related applications such as product delivery, purchasing good and/or products, selling goods and or products, trading goods/products, information delivery, and collection of consumer data. In addition, various kinds of media content besides advertisements may be delivered via the network advertisement serving machines, including, but not limited to, interactive media content, video games, audio content, video content, web sites, 3-D content, virtual reality, animation, still images, multimedia, and hypermedia.

The systems and methods described herein include, among other things, advertisement serving devices. An advertisement serving device may have a media display for presenting video content and, optionally, audio content. An advertisement server can operate within or remotely from the device and select media content from an onboard or remotely stored library of media content. The selected media content may be presented to consumers via the media display. The advertisement server may include business logic that selects the media content based on targeting criteria encoded within the business logic. The business logic may be loaded remotely. Optionally but preferably, the advertisement serving machines include an Internet connection, or another network connection, for exchanging content such as media content and business rules with a control server. The control server may be a remote server. In one embodiment, the advertisement serving device may operate as a device on a computer network. Thus, it may be understood by those of skill in the art, that the systems and methods described herein also include networks of geographically and logically distributed advertisement serving devices.

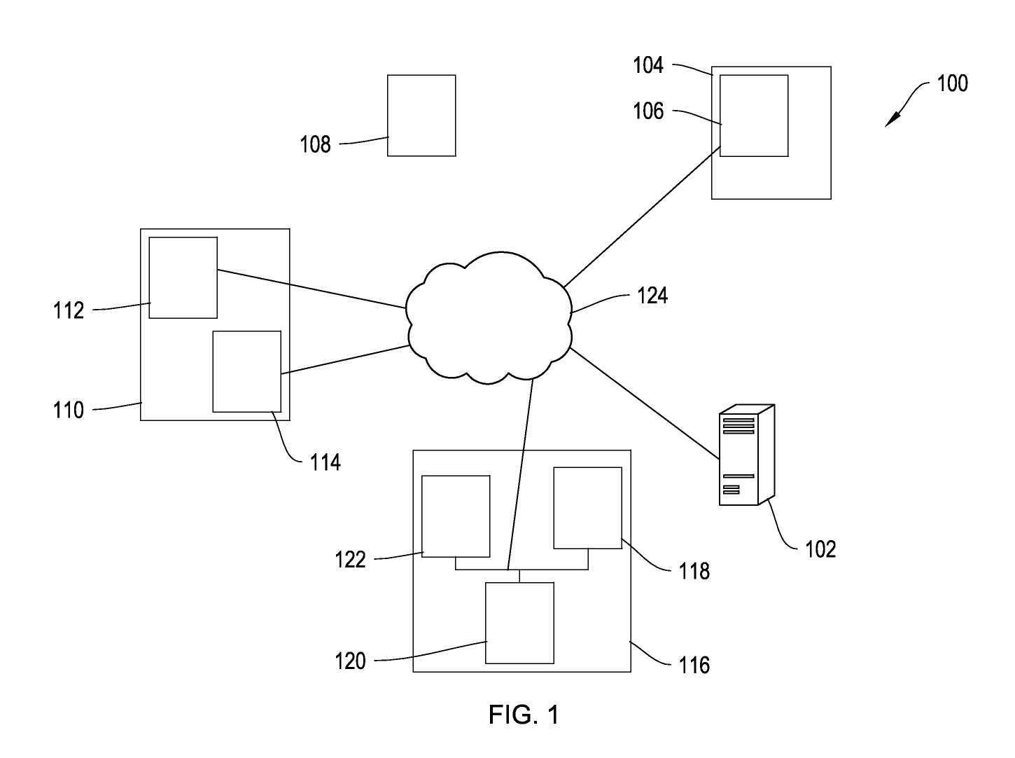

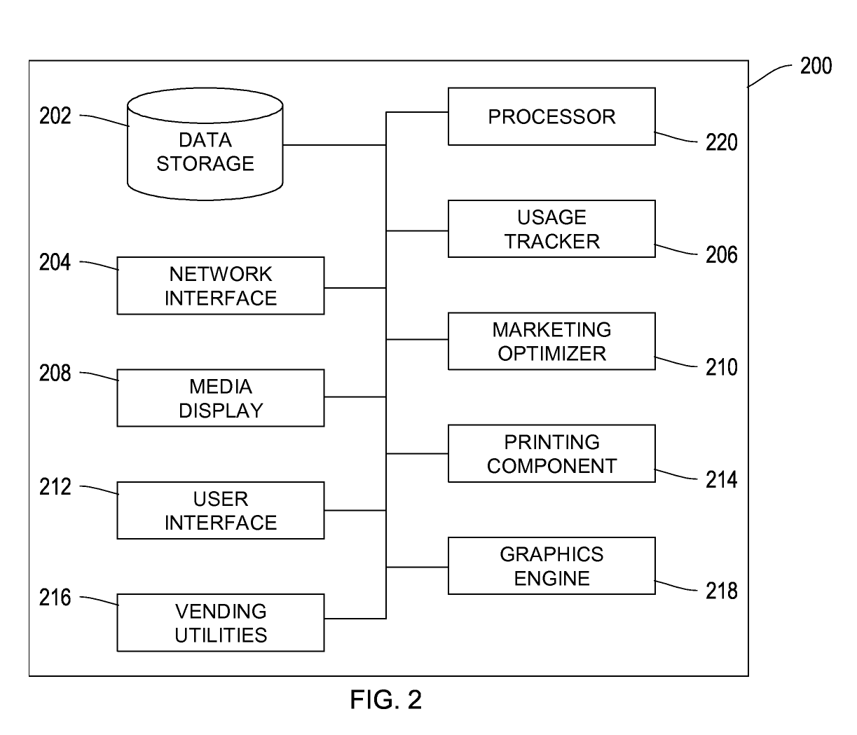

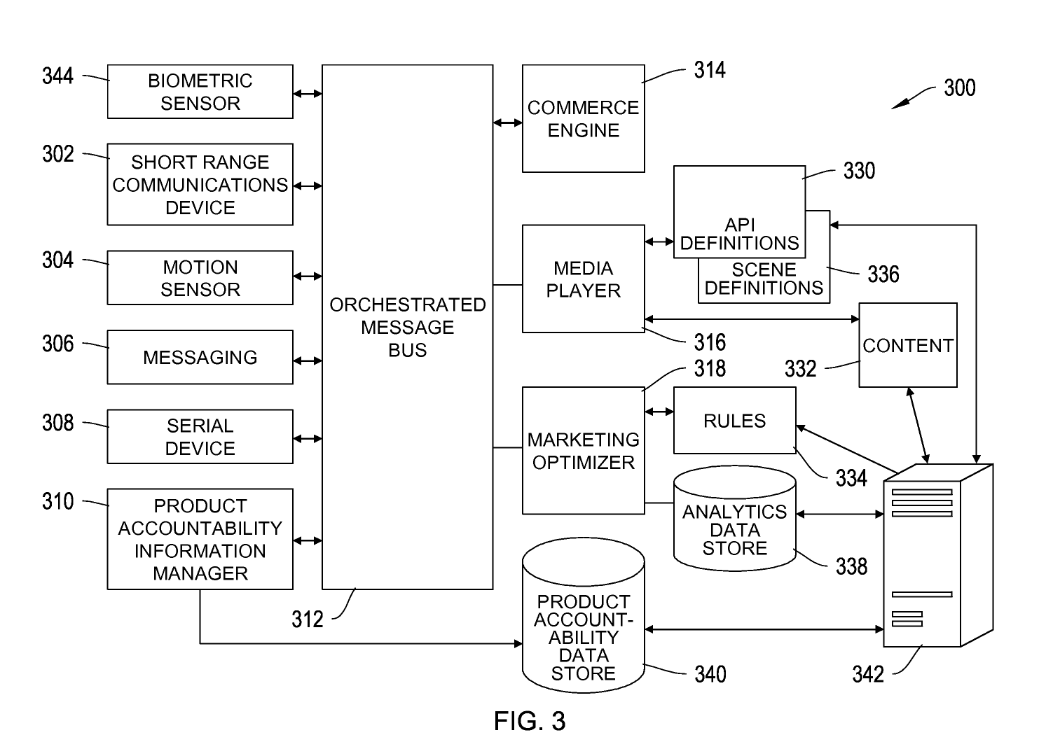

FIG. 1 includes a network diagram of an advertisement serving system according to several illustrative embodiments of the invention. System 100 includes advertisement serving devices 106, 108, 112, 114, 122, 118, 120 and 122. Each advertisement serving devices 106, 108, 112, 114, 122, 118, 120 and 122 may be configured with the same or different set of capabilities. For instance, some may be equipped with a media display while others may not. Details regarding the devices 106, 108, 112, 114, 122, 118, 120 and 122 are discussed at length in relation to FIGS. 2 and 3.

Devices 106, 108, 112, 114, 122, 118, 120 and 122 may be located in fixed locations, or may be mobile and free to roam to different locations. In one embodiment, advertisement serving device 106 may be located in building 104. Device 106 may be connected to network 124 and configured to communicate with other connected devices on network 124. In another embodiment, advertisement serving devices 112 and 114 may be located in a different location from device 106. Devices 112 and 114 may be connected to network 124 and configured to communicate with other connected devices on network 124. For instance, devices 112 and 114 may be located at different parts of a shopping mall. Devices 118, 120 and 122 may be located at a different location from devices 106, 112 and 114. For example, devices 118, 120 and 122 may be located within an office building. Devices 118, 120, 122 may be communicatively coupled with each other to facilitate communications between devices. Advertising serving device 108 may not be connected to network 124 continuously, or may only connect to network 124 as needed. Device 108 may operate as a stand-alone device.

Network 124 may be the Internet, local area network, wide area network, metropolitan area network, personal area network, virtual private network, campus area network, storage area network, wireless network, Ethernet, optical fiber network, satellite network, short range wireless network (e.g., Bluetooth), cellular network, or any other suitable communications networks. Network 124 may be configured in various topologies including but not limited to, bus network, star network, ring network, mesh network, star-bus network, tree, hierarchical topology network or any suitable topology.

Advertisement serving devices 106, 108, 112, 114, 122, 118, 120 and 122 may be located wherever consumers are located. For examples, devices 106, 108, 112, 114, 122, 118, 120 and 122 may be located in places including, but not limited to, business office, outside of a building, retail store, library, school, cinema, shopping mall, gym, swimming pool, stadium, arena, convention center, hospital, airport, airplane, bus, bus stops, ferry, ferry terminal, train, train stations, park, home, restaurant, bar, street, freeway and fairgrounds.

Control server 102, communicatively connected with network 124, may be configured to send data to other devices connected to the network. Control server 102 may be implemented on a general purpose computer, super computer, specific purpose computer, or any suitable computing machine. Control server 102 may include a file server. In some embodiments, control server 102 may include a web server configured to serve web pages to devices 106, 108, 112, 114, 122, 118, 120 and 122. Server 102 may include storage (e.g., memory, hard disk, flash drive), a processor (or more than one), network interface for communicating with network 124, or any suitable hardware and software for serving, tracking, and managing devices 106, 108, 112, 114, 122, 118, 120 and 122. Storage may include a database for managing data. Server 102 may include a display and user interface for administrators to access and configure server 102. Server 102 may be accessed locally or remotely.

Control server 102 may control the operation of the network connected advertising serving devices 106, 108, 112, 114, 122, 118, 120 and 122. Typically, the control server will deliver media content, such as advertising content, and business rules (e.g., deliver targeting instructions) and data, to devices 106, 108, 112, 114, 122, 118, 120 and 122. Control server 102 may also collect data (e.g., usage statistics, product accountability information) from devices 106, 108, 112, 114, 122, 118, 120 and 122, where that data is representative of system status, system operational status, sales and inventory data and other relevant information. In some embodiments, control server 102 may be configured to process payments if devices 106, 108, 112, 114, 122, 118, 120 and 122 are configured to sell or buy goods/services.

In operation, system 100 allows an administrator to use the control server to load media content and business rules, such as rules for how advertising content may be selected for display during a particular part of day, to the advertisement serving devices. Devices 106, 108, 112, 114, 122, 118, 120 and 122 may then behave as a distributed network of advertisement serving devices. Some of which are web-enabled, and some of which, such as device 108, being off-network and requiring manual loading of data, but providing stand alone operation.

In some embodiments, devices 106, 112, 114, 122, 118, 120 and 122 that are web-enabled may be configured with a web browser for displaying web pages served by control server 102. Business rules maybe embedded in client-side scripts or server-side scripts. Content delivered on web pages may be images, videos, animations, audio, or any suitable media. Devices 108 may serve web pages from a local repository.

The feature of remotely controlling devices 106, 108, 112, 114, 122, 118, 120 and 122 enables system 100 to be flexible in response to changing business conditions. Based at least in part on data collected by devices 106, 108, 112, 114, 122, 118, 120 and 122, business rules may be subject to updates. For example, control server 102 may be configured to calculate the return on investment (ROI) for advertisements displayed on devices 106, 108, 112, 114, 122, 118, 120 and 122, and change business rules to reflect changes in ROI. Changes to business rules may be done online or offline. In another example, control server 102 may update business rules depending on changes to the bids made by advertisers. More specifically, controls server 102 may remotely instruct devices 106, 108, 112, 114, 122, 118, 120 and 122 to remove certain advertisements if an advertiser has withdrawn its bids.

FIG. 2 includes a functional block diagram of an advertisement serving device according to an illustrative embodiment of the invention. Advertisement service devices may be implemented with various combinations of components suitable for facilitating commerce. Features of advertisement service device 200 may include at least one of, among others, ability to deliver media content, and track user statistics and vending products/services. Details regarding various processes within an advertisement serving device are discussed at length in relation to FIG. 3. Advertising serving device 200 includes data storage 202, processor 220, network interface 204. In one embodiment, the components in device 200 may communicate with each other on a bus, such as a MDB (multi-drop bus). Data storage 202 may be random access memory, hard drive, flash memory, or any suitable data storage component. Data storage 202 may be configured to store media content, business rules, usage data or commerce data. For example, data storage 202 may be configured to store a repository of image files. The data may be pre-loaded on the device, or may be added to and/or updated by another source such as control server 102.

Processor 220 may be a central processing unit, microprocessor, digital signals processor, field programmable gate array or any suitable computing processor. Network interface 204 may be any suitable device including but not limited to network cards, network adapter, Ethernet card, data modem, wireless network interface card, gigabit Ethernet interface or router. Network interface may be configured to communicate with Bluetooth enabled devices. Network interface 204 may be configured to communicate with other devices via a computer network, such as network 124. Furthermore, network interface 204 may be configured to transport data such as media content, business rules, usage data, or commerce data.

In one embodiment, advertisement serving device 200 may include media display 208. Media display 208 may be a liquid crystal display, light emitting diode display, touch screen, projection display, plasma display, rotating banner or any other suitable displays. Media displays may be configured to display still images, video, animation, 3-D animation, holograms, virtual reality and/or video games. Media displays may be equipped with audio speakers or other sensory output (e.g., haptic vibrations, water, heat, or light). Any other suitable media delivery systems may be used for delivering media content stored in data storage 202. For instance, device 200 may include an LED monitor and speakers for showing a movie trailer. Content displayed on media display 208 may be dictated by business rules stored in data storage 202. For instance, business rules may select media content to be displayed on media display 208.

In certain embodiments, advertisement serving device 200 may include user interface 212. User interface 212 may be part of the media display configured as a touch screen. User interface 212 may include a keyboard, mouse, joystick, button, trackball, fingerprint reader, picture camera, video camera, microphone, motion sensor, heat sensor, biometric sensor (e.g., fingerprint, hand, facial, and/or eye scanner), radio receiver, barcode reader or any suitable user interface for receiving input from a user and interacting with device 200. For instance, device 200 may be configured to take photos of users, and provide a keyboard for submitting their email address for sending the photo. In some embodiments, business rules may choose media content based on certain user inputs. For instance, if a motion sensor detects a high volume of people walking by device 200, a particular media content may be selected for targeting crowds of people. In another instance, a biometric sensor may be employed to detect physical characteristics of a person within the vicinity of a serving device. The detected physical characteristics may be used to determine gender, age, ethnicity, weight, height, health, and/or personal attributes via the biometric sensor. In one configuration, the biometric sensor employ facial recognition to determine physical characteristics. As another feature, a particular advertisement with the highest bid amount may be displayed if a high amount of traffic is detected.

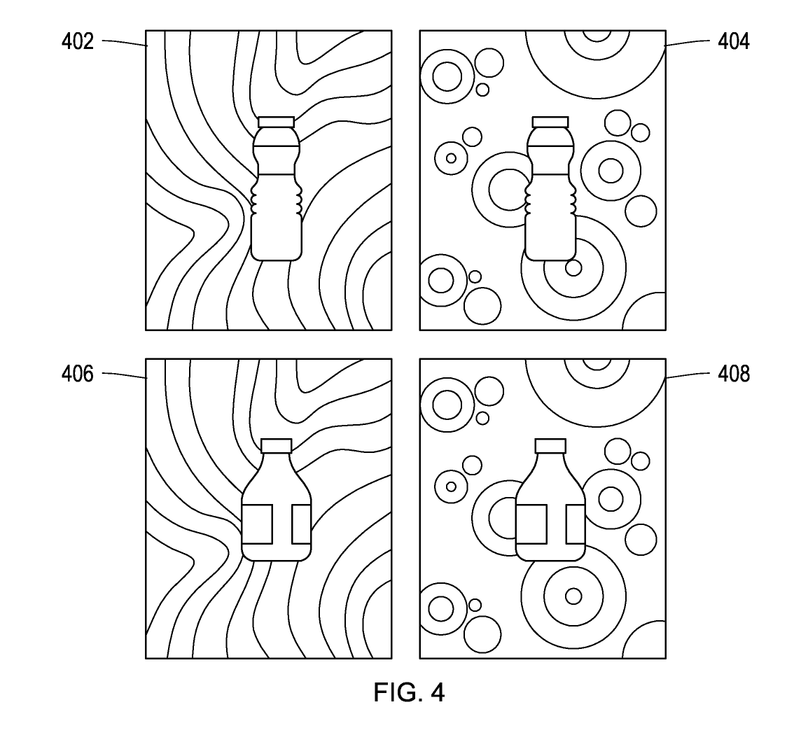

In one embodiment, advertisement serving device 200 may include vending utilities 216. Vending utilities 216 may include devices for processing payment and dispensing products. Payment may include cash, credit card, ATM cards, stored value cards, tokens, PayPal, check, text messaging payment, near field payment, membership account payment, EBT cards, Linden dollars or any suitable payment. Vending utilities 216 may be configured to use a digital exchange mechanism for tracking and auditing sales (e.g., product accountability). Different payment systems and components of vending utilities 216 and user interface 212 may be connected via an interface bus, or any suitable bus. Mechanical devices may be included for dispensing products. Such devices may include bottle/can dispenser, beverage dispenser, item dispenser, food dispenser, compartments for storing items, claw for vending items, or any suitable product dispenser. Vending utilities 216 may be configured to make certain products available based at least in part on business rules stored in data storage 202. For example, vending utilities 216 may be configured to dispense certain coupons based on the time of day (e.g., coffee coupons in the morning, rebate coupons during a promotional period). Examples of vending utilities or other commerce-related applications are discussed at length in FIGS. 4-7.

In one embodiment, advertisement serving device 200 may include usage tracker 206. Usage tracker 206 may be a software program for managing usage statistics. Usage tracker 206 may also be implemented in hardware or a combination of hardware and software. Managing (e.g., receiving, storing, transmitting) usage statistics enables advertisement serving device 200 to optimize the strategy for media content delivery. Usage tracker 206 may optimize the strategy by changing business rules stored in 202 to affect how and when media content is delivered. For example, if a particular promotional coupon has been printed relatively fewer times than other promotional coupons, the coupon may be removed from the display screen (e.g., via a change in the business rules), or made more prominent on the display screen.

Usage tracker 206 may work in conjunction with marketing optimizer 210 and marketing optimizer 318 to improve the strategy of a particular marketing campaign. Usage tracker 206 may communicate usage statistics to a remote server such as control server 102 via network interface 204 over network 124. Usage statistics collected by usage tracker 206 may include frequency of use, user input log, vending statistics, commerce statistics, activity logs, response rates, number of impressions and exposure rates. Usage tracker 206 may derive usage patterns using statistical analysis methods and drive the behavior of device 200 by affecting the business rules operating on the media content displayed. In some embodiments, usage tracker 206 may be configured to generate real-time or periodic reports to advertisers and administrators.

In another embodiment, advertisement serving device 200 may include marketing optimizer 210. BridgeTrack® is an example of a marketing tool developed by Sapient Corporation of Boston, Mass., USA. BridgeTrack® is a digital marketing suite that gives marketers the ability to optimize their marketing efforts across various of digital or Internet-based advertising channels by providing access to real-time data and analytics about consumer behavior. Any other suitable marketing optimizer may also be used as marketing optimizer 210. Marketing optimizer 210 may be integrated with media content and business rules stored in data storage 202. Business rules may work in conjunction with marketing optimizer 210 to select media content based on factors such as: location of device 200, businesses located near device 200, time of day, day in the week, day in the year, season, holidays, retail sale periods, cultural events, current news events, sports events, special events, relationship of device 200 with other devices. For instance, business rules may differ for a device located on a college campus versus a device located on a beach. Business rules may also differ for a device operating at 3 a.m. versus a device operating at 11 a.m. Business rules may also differ for a device operating before Christmas versus a device operating before Valentine's Day.

In certain embodiments, business rules are based on the geographical location of the device. An advertisement serving device in a public restroom near the theatre district of a city may be configured to display advertisements targeted for people who enjoy musicals. An advertisement device located in a particular part of a theme park may be configured to display advertisements for stores or restaurants located in that part of the theme park.

In some embodiments, business rules may depend on the geographical relationships of the network of advertisement serving devices. For example, a plurality of advertisement serving devices in a museum equipped with RFID (radio frequency identification) trackers may display a marketing campaign (e.g., a series of advertisements) tailored to people walking from one part of a museum to another. Media content delivered on the plurality of advertisement serving devices in the museum may be tailored to discuss the art work in a particular exhibition in relation to the art work in a different exhibition (e.g., compare different time periods of Van Gogh's work). Any suitable business rules may be used to affect the display of media content on advertisement serving device 200.

In certain embodiments, marketing optimizer 210 may experiment with a random business rule or use a potential business rule to test the effectiveness of the business rule (e.g., by measuring ROI). Based on the success or failure of the test, the business rule may be modified. For example, marketing optimizer 210 may configure system 200 to vend a particular product at $1.50. If sales do not meet the target amount over a period of time, marketing optimizer 210 may configure system 200 to vend the product for $1.25. Typically, marketing optimizer 210 supports the serving of advertisements based on a pre-defined set of business rules. Over time, marketing optimizer 210 may update the business rules to maximize ROI (Return on Investment). Such updates may occur in real time (online) or offline. Alternatively marketing optimizer 210 may submit reports to a remote server such as control server 102 for further analysis. Control server 102 may then be responsible for updating business rules stored in data storage 202. In some embodiments, marketing optimizer 210 may be responsible for managing marketing campaigns for a plurality of advertisement serving devices. In certain embodiments, marketing optimizer 210 may be configured to generate reports for advertisers. For instance, advertisers may be able to view a report regarding the ROI of the advertisements being displayed on a group of advertisement serving devices.

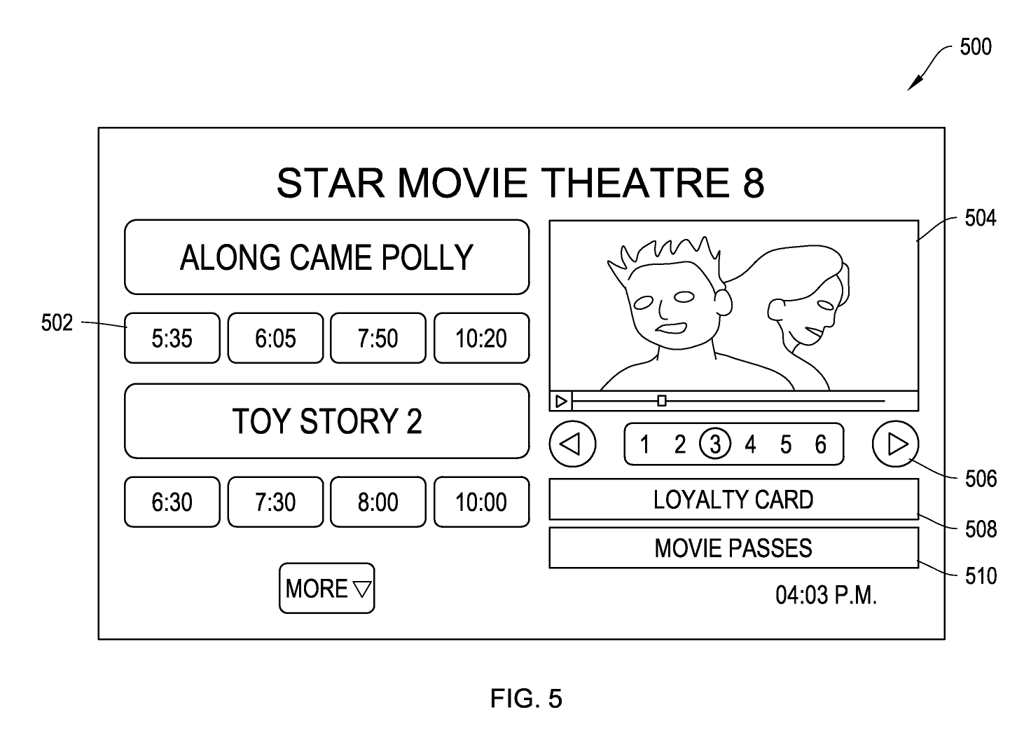

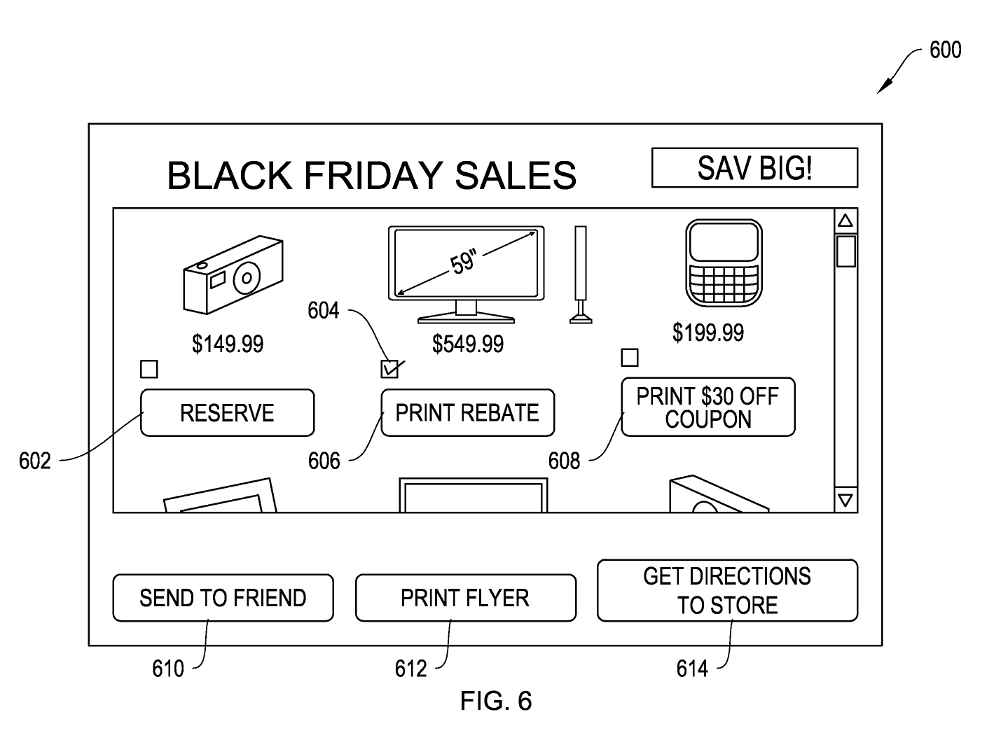

In yet another embodiment, advertisement serving device 200 may include printing component 214 for dispensing printed media to consumers. Printing component 214 may dispense coupons, advertisements, flyers, membership cards, photos, t-shirts, memorabilia, certificates, or any kind of printed media. Printing component 214 may be integrated with vending utilities 216 if utilities 216 is configured to dispense printed items. An example application of printing component 214 is discussed at length in relation to FIGS. 5 and 6. Printing component 216 may be subjected to business rules stored in data storage 202. For instance, printing component may be configured to print different kinds of coupons based on shopping seasons.

In some embodiments, advertisement service device 200 may include graphics engine 218 for rendering media content based on templates and business rules stored in data storage 202. Graphics engine 218 may be Adobe Flash player, a video player, a media player an animation engine, a 3-D gaming engine or any suitable processes for rendering media content for display. Graphics engine 218 may be implemented in software, or in hardware such as a graphics card. For instance, graphics engine may be configured to render interactive advertisements encoded in, but not limited to .exe, .flv and/or .swf files. Graphics engine may also be configured to show a moving image video with advertisement banners whose layout is specified in a .xml file. Any other suitable graphics engine may be used. Details regarding graphics engine is discussed in relation to FIG. 3.

Although FIG. 2 graphically depicts the system as functional block elements, it will be apparent to one of ordinary skill in the art that these elements can be realized as computer programs or portions of computer programs that are capable of running on a data processor. Moreover, although FIG. 2 depicts the system as a largely integrated unit of usage tracker 206, marketing optimizer 210, graphics engine 218, etc. It will be apparent to those of ordinary skill in the art that this is only one embodiment, and that the invention can be embodied as a computer program that can operate across multiple devices, and therefore have a distributed architecture. Thus, the depicted embodiments are merely illustrative and not limiting in any way. The software components themselves can be implemented as C language computer programs, or a computer program written in any high level language including C++, Fortran, Java or BASIC. Additionally, in an embodiment where microcontrollers, DSPs, or other embedded processors are employed, the system may be realized as a computer program written in microcode or written in a high level language and compiled down to microcode that can be executed on the platform employed. The development of such systems is known to those of skill in the art, and such techniques are set forth in Digital Signal Processing Applications with the TMS320 Family, Volumes I, II, and III, Texas Instruments (1990). Additionally, general techniques for high level programming are known, and set forth in, for example, Stephen G. Kochan, Programming in C, Hayden Publishing (1983).

FIG. 3 includes an architecture diagram of the advertisement serving system according to an illustrative embodiment of the invention. Advertisement serving system 300 includes external interfaces, which may be configured to communicate with external devices. Such external interfaces may include short range communications device 302 (e.g., Bluetooth, RFID tags), motion sensors, messaging 306 (e.g., SMS, MMS, instant messaging, RSS feed, HTTP, HTTPS, and the like), and serial device 308 (e.g., game controller, keyboard, other user interface devices discussed in relation to user interface 212). External interfaces may serve to receive input from users or other devices. For instance, a Bluetooth-enabled cell phone may be configured to communicate with short range communications device 302 to download music tracks purchased using system 300. In another instance, a Bluetooth-enabled device may purchase goods and/or services via short range communications device 302 using mobile payment protocols (e.g., Rollpay by Rollcomm).

Users may also change the behavior of system 300 through motion sensor 304. Specifically, the motion of people passing by an advertisement serving machine may trigger certain behaviors of system 300. For instance, advertisement serving system 300 may track the volume of consumers that passes by the advertisement serving machine. In another instance, system 300 may display a specific advertisement when the motion sensor detects a person passing by (e.g., the advertisement as selected by a business rule); the specific advertisement may be a bright animation designed to grab the person's attention. A motion sensor may also be used to interact with the system as a control device. For example, it may be configured to interpret and recognize hand gestures that are made in front of a motion sensor as commands for controlling an interactive application running on system 300.

In some embodiments, a user may communicate with system 300 using a serial device by plugging in a device to a serial port (e.g., Firewire, USB). For example, a user may plug in a portable media device via USB to charge the media device at advertisement serving system 300. The user may be charged by the minute while advertisements are being displayed in front of the user.

Messaging is yet another way to communicate with system 300. In one embodiment, users may send a text message to system 300 to subscribe to a list for receiving text messaging updates. These updates may be for news events, shopping deals, or emergency warnings. A user may also send a text message using a cell phone to system 300 to request a ringtone be sent back to the cell phone.

Any of the short range communication device 302, motion sensor 304, biometric sensor 344, messaging 306, or serial device 308 may be communicatively connected to orchestrated message bus 312. Orchestrated message bus 312 may be configured to manage system components and processes within defined system orchestrations. More specifically, orchestrated message bus 312 may enable the integration of different devices/processes and allow for the automation of business processes within advertisement serving system 300. Bus 312 may be configured to process messages from various connected components, monitoring business processes such that system 300 behaves according to specified orchestrations and automations. For instance, bus 312 may facilitate the communications between short range communications device 302 and commerce engine 314. Bus 312 may mediate various components, which may be running on different platforms, within system 300. Suitable conventional systems may include .NET Enterprise Service Bus or any commercial message-oriented middleware. Bus 312 may be configured to be expendable and/or scalable such that additional devices and/or sensors (e.g., a GPS device to determine device location) may be connected and/or disconnected from the bus 312.

Another component that may be connected to orchestrated message bus 312 is product accountability information manager 310. Manager 310 may be configured to audit transactions made using system 300 (e.g., selling items and receiving payment). Manager 310 may include conventional systems such as a digital exchange system or any other suitable product auditing system. Manager 310 may be used in system 300 to manage the transaction of goods and/or services for at least one advertisement serving devices. The data collected by manager 310 may be sent to and stored in product accountability data store 340. Data store 340 may be implemented as a relational database. Control server 342 may be configured to access data store 340 for purpose of tracking the commercial success of advertisement serving system 300. In some embodiments, control server 342 may be configured to access data store 340 to remotely manage inventory. Furthermore, the product accountability files information may be communicated to/from the commerce engine 314 such that the state and behavior of the system within the commerce engine 314 may be updated. In certain embodiments, the commerce engine 314 is configured to interface with various payment systems (e.g., coin mechanism, bill validator, cashless, etc). The commerce engine 314 may be communicatively connected to a payment device via a bus driver or some other interface.

The commerce engine 314 may include an event queue configured to provide events to the engine 314 during operation. The event queue may provide notifications to the commerce engine if changes are made to business rules and/or media content. The commerce engine 314 may include a processor for processing instructions of an operating system of the advertising serving system 300, and/or may be configured to monitor processes running on media player 316, marketing optimizer 318 or any other processes. For instance, the engine 314 may provide a platform for applications such as media player 316 and marketing optimizer 318. The commerce engine 314 may also be configured to provide an interface to and/or manage hardware devices such as short range communications device 302, motion sensor 304, messaging 306, or serial device 308. The commerce engine 314 may be configured to provide product dispensing, vending services, point-of-sale (POS) services, payment services, electronic and/or other commerce services, and/or supervise other components of the system 300.

Other than basic operations, system 300 may be configured with media player 316 for compiling and generating media content for display. Using content 332, media player 316 may use API (application programming interface) definition 330 to construct displays of media content. For example, API definition 330 may be a media codec for displaying video content. In another example, API definition 330 may be a hypertext markup language file for rendering web pages, where the media content, such as images, text, or other multimedia, may be provided by content 332. In yet another example, API definition may be an XML file for specifying components of an advertisement and references a collection of media contents.

In some embodiments, advertisement serving system 300 may be equipped with marketing optimizer 318, which may be configured to monitor usage statistics. Details regarding marketing optimizer 318 is also discussed in relation to marketing optimizer 210 of FIG. 2. Usage statistics may be stored in analytics data store 338, which may be accessible by control server 342. Data store 338 may be implemented as a relational database. Usage statistics may be used for optimizing a marketing campaign. Control server 342 may be configured to provide rules 334 and scene definition 336. Rules 334 and scene definition 336 provide templates and behavior rules for the marketing campaign. For example, scene definition 336 may provide a template for an advertisement specifying the regions of a screen. Scene definitions may also provide attributes of a scenario, such as a list of retailers near the advertisement serving machine. Rules 334 may provide instructions and conditions for displaying different content in each of the screen regions. Conditions may be supplied by scene definition 336. For example, a rule may select different advertisement banners to be displayed in the top region of a display screen, depending on the time of day.

Although FIG. 3 graphically depicts the system as functional block elements, it will be apparent to one of ordinary skill in the art that these elements can be realized as computer programs or portions of computer programs that are capable of running on a data processor. Moreover, although FIG. 3 depicts the system as a largely integrated unit of commerce engine 314, media player 316, marketing optimizer 318, etc., it will be apparent to those of ordinary skill in the art that this is only one embodiment, and that the invention can be embodied as a computer program that can operate across multiple devices, and therefore have a distributed architecture. Thus, the depicted embodiments are merely illustrative and not limiting in any way.

FIG. 4 includes a set of media content design variations according to an illustrative embodiment of the invention. Designs 402, 404, 406, and 408 illustrate how media content may be configured using templates and media content selected by business rules. By employing business rules, different media content may be selected for the design. Media content may be selected using rules 334 and/or scene definition 336 using marketing optimizer 318 or marketing optimizer 210. Media player 316 and/or graphics engine 218 may use content 332 and API definition 330 to present the tailored media content (e.g., targeted advertisement). For instance, a template for a background and item may be defined to create varying combinations. The template may combine a background image with a product image in the foreground. Rules 334 may dictate when certain combinations are suitable. Different backgrounds may be interchangeable based on the business rule applied. For example, a more colorful background image may be used (as compared to a less colorful background) if a sensors detects that it is likely that the device is being used by a child (based on the height of the person). Other kinds of suitable business rules may dictate the selection of media content to be used for the template.

As an illustration, designs 402, 404, 406 and 408 are generated with a template, two background images and two items. Depending on the business rules, the background image may change while the item in the foreground remains the same, as illustrated in designs 402 and 404. Also, the foreground item may also change while the background remains the same, as illustrated in designs 404 and 408 (illustrated in design 402 and 406 as well). Separate rules may independently or dependently dictate which background image or item may be chosen for a particular advertisement.

FIG. 5 includes a wireframe or illustration of a commerce application according to an illustrative embodiment of the invention. Commerce application 500 as shown is an interactive application for a user to, among other things, purchase movie tickets. Commerce application 500 may be displayed on media display 208. Processes for enabling purchases to be made are discussed at length in relation to FIGS. 2 and 3. The advertisement serving device may be located near or within a movie theatre. For instance, an advertisement serving device may be located at the lobby of a movie theatre equipped with a touch screen (e.g., user interface 212). A user may touch and click on button 502 to purchase tickets for the 5:35 showing of the movie “Along Came Polly.” To sell movie tickets, the advertisement serving device may be equipped with a payment device for accepting cash, credit card, loyalty card, pre-paid cards, movie vouchers, etc.

Commerce application 500 may be configured to display different media content, button options or purchasing options based on the business rules (e.g., rules 334) stored in data storage 202. Graphics engine 218 and/or media player 316 may be used to render such media content using templates. Suitable business rules may include factors such as: time of day, availability of tickets, recent movie releases, gift season, or popularity of movies on screen. In one embodiment, media player 504 may be integrated within the commerce application to display movie trailers. Media player 504 may also display advertisements for products and/or services. In addition, media player 504 may be configured to display informational announcements. By clicking 506, a user may browse for other media content available on the commerce application. In some embodiments, the advertisement serving device may be equipped with a printing component (e.g., printing component 214 in FIG. 2) for dispensing loyalty cards and movie passes. A user may use button 508 to register for a loyalty card and may use button 510 to print movie passes (e.g., vouchers or gift certificates). Usage statistics (e.g., clicks, viewing usage, purchase history) may be logged by usage tracker 206, processed by marketing optimizer 210 and stored in analytics data store 338 or data storage 202.

FIG. 6 includes another wireframe or illustration of a commerce application according to an illustrative embodiment of the invention. Commerce application 600 may be used to display a sales flyer for a retail store on media display 208. Button 602 allows a customer to reserve a particular product in stock for later pick-up. A user may also select (e.g., check box 604) to send the selected deal (e.g., button 610) to a friend via text messaging or email. By clicking button 608, a user may elect to print a manufacturer's coupon for a cell phone. A user may print the entire flyer by clicking on button 612 (printing feature may be enabled by printing component 214). To obtain more information, such as directions to the retail store, a user may click on button 614. Based on various business rules, the display of the commerce application may vary. For example, if a product is out of stock, commerce application 600 may remove the item from the application. Alternatively, commerce application 600 may display a “rain check” button for users to reserve the product when it becomes in stock. By the same token, the color scheme of commerce application 600 may change depending on the time of the year. For example, the color scheme may be green and red before Christmas.

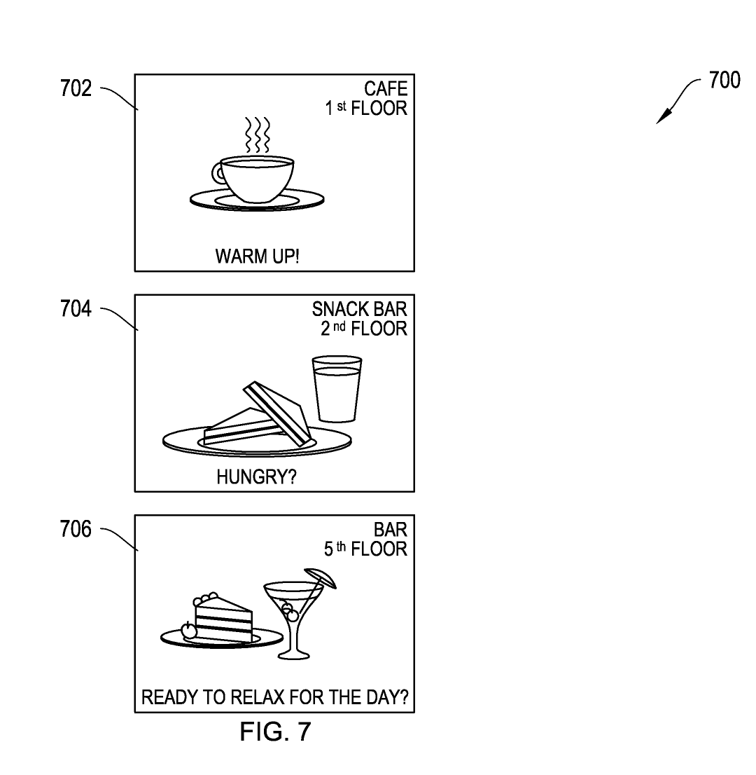

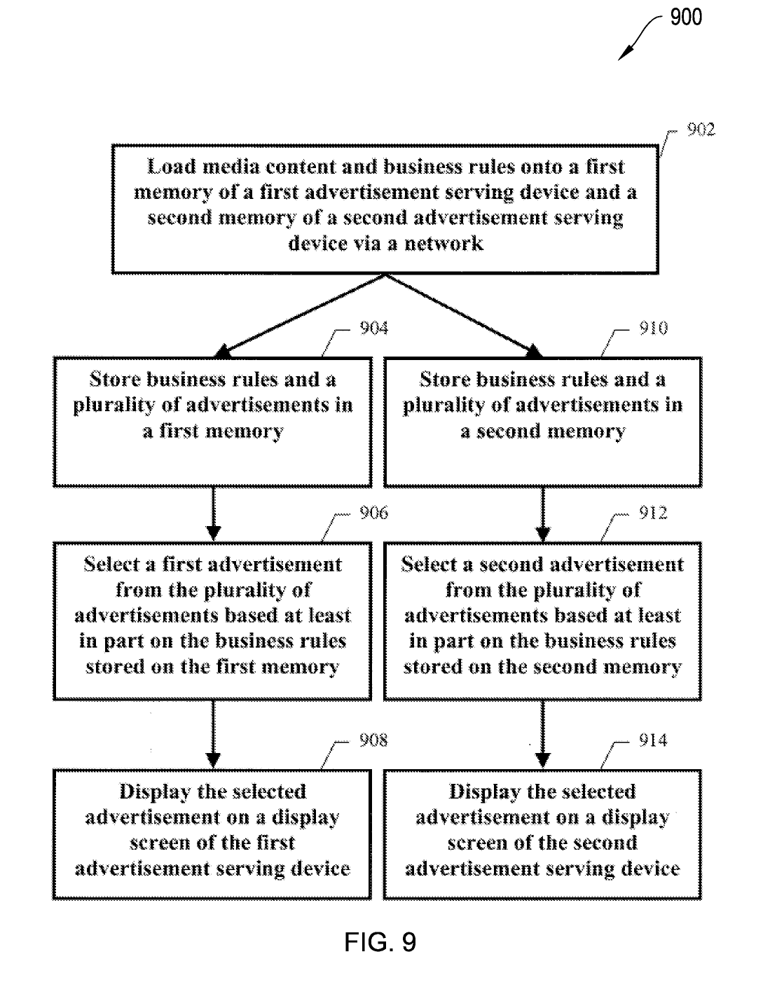

FIG. 7 includes a set of media content according to an illustrative embodiment of the invention. Besides using business rules for a single advertisement serving device, business rules may also control the a plurality advertisement serving devices. Advertisements 702, 704 and 706 illustrates a series of advertisements placed within a multi-level shopping mall. Business rules may select different advertisements to be shown for different locations within the shopping mall to effectively leverage targeted marketing for a marketing campaign in the shopping center. For instance, advertisement 702 may be selected for display on an advertisement serving device located at the entrance of a shopping mall on a cold day. Advertisement 702 may be related to the cafe, in particular, the hot beverages served at the cafe. Advertisement 704 may be selected for display on an advertisement serving device located near an escalator going up to the second floor during lunch hours. Advertisement 704 may be related to the snack bar located on the second floor of the shopping center. Advertisement 706 may be selected for display on an advertisement serving device located near a cashier within a department store from 4 p.m. to 7 p.m. (e.g., happy hour). Advertisement 706 may be related to a bar/lounge located within the shopping center. Method for implementing system 700 is discussed at length in relation to FIG. 9.

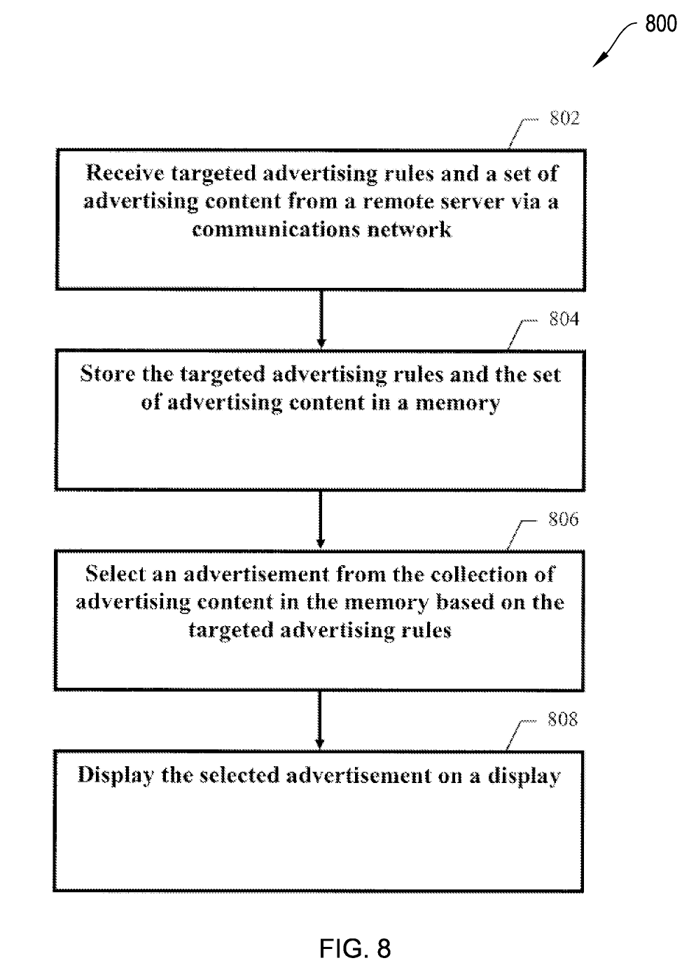

FIG. 8 includes a flow diagram of a method for distributing media content according to an illustrative embodiment of the invention. Method 800 comprises step 802, 804, 806, and 808. At step 802, targeted advertising rules and a set of advertising content from a control server may be received via a communications network. For example, control server 102 and control server 342 may transmit the targeted advertising rules (e.g., rules 334) and the set of advertising content (e.g. content 332) to an advertisement serving device. In some embodiments, the rules may be unrelated to advertising, and the set of advertising content may be a collection of media content (e.g., images, text, video, etc.).

At step 804, the targeted advertising rules and the set of advertising content may be stored in a memory. For example, the targeted advertising rules (e.g., rules 334) may be stored in data storage 202 of advertisement serving device. At step 806, an advertisement may be selected from the set of advertising content in the memory (e.g., data store 202) based on the targeted advertising rules (e.g., rules 334). In some embodiments, the selected advertisement may be media content that makes up only a portion of a larger advertisement (e.g., an image used in a web page). The system and method of selecting an advertisement based on business rules is discussed at length in relation FIGS. 2-4.

At step 808, the selected advertisement may be displayed on a display, such as media display 208. The advertisement may be rendered and/or generated by media player 316 and/or graphics engine 218.

FIG. 9 includes a flow diagram of a method for distributing media content according to another illustrative embodiment of the invention. Method 900 comprises step 902, 904, 906, 908, 910, 912, and 914. At step 902, media content and business rules may be loaded onto a first memory of a first advertisement device and a second memory of a second advertisement device via a network. At step 904 and step 910, business rules and a plurality of advertisements are stored in a first and second memory. For example, content 332 and rules 334 may be loaded and stored on data storage 202 of two separate advertisement serving devices.

At step 906, a first advertisement may be selected from the plurality of advertisements based at least in part on the business rules stored on the first memory. At step 912, a second advertisement may be selected from the plurality of advertisements based at least in part on the business rules stored on the second memory. Business rules stored on the first memory and the second memory may be the same or different. Details regarding the selection of advertisement is discussed at length in relation to FIGS. 3 and 4.

At step 908, the selected advertisement may be displayed on a display screen of the first advertisement serving device. At step 914, the selected advertisement may be displayed on a display screen of the second advertisement serving device. Display screens on the first and second advertisement serving device may be media display 208 of advertisement serving device 200.

It will be apparent to those of ordinary skill in the art that methods involved in the present invention may be embodied in a computer program product that includes a computer usable and/or readable medium. For example, such a computer usable medium may consist of a read only memory device, such as a CD ROM disk or conventional ROM devices, or a random access memory, such as a hard drive device or a computer diskette, or flash memory device having a computer readable program code stored thereon. A program may include a complete software application, a portion of an application, a portion of software code or coding, one or more lines of script or code, source code, or executable code.

What is claimed is:

1. A system for distributing media content comprising:
a control server in communication with a data network, the control server including media content and business rules associated with the use of the media content;
a first advertisement serving device in communication with the data network including:
a network interface configured to receive the media content and the business rules from the control server via the data network;
a processor, in communication with the network interface, configured to select a first portion of the media content based at least in part on the business rules received from the control server; and
a display for displaying the first portion of selected media content.

2. The system of claim 1, wherein the first portion of the media content includes an advertisement.

3. The system of claim 2, wherein the advertisement is related to at least one of a product and service.

4. The system in claim 1, wherein the business rules include rules for selecting the first portion of the media content for display based at least in part on the geographic location of the first advertisement serving device.

5. The system in claim 1, wherein the business rules include rules for selecting the first portion of the media content based at least in part on a business located within proximity of the advertisement serving device.

6. The system in claim 1, wherein the business rules include rules for selecting the first portion of the media content based on at least one of the time of day, day in the week, day in the year, season, holidays, retail sales periods, and cultural events.

7. The system of claim 1, wherein the advertisement serving device further comprises a printing component configured to provide printed media for a consumer.

8. The system of claim 7, wherein the printed media includes at least one of a ticket, a pass, a coupon, a voucher, a loyalty card, a text message, a photograph, an image, a token, a note of monetary value, credit card, and gift card.

9. The system in claim 1, wherein the network interface is configured to send usage data to the control server.

10. The system of claim 9, wherein the usage data includes usage information associated with the first advertisement serving device.

11. The system of claim 1 comprising a second advertisement serving device in communication with the control server via the data network.

12. The system of claim 3, wherein the first portion of selected media content is related to the at least one of a product and service being dispensed via the advertisement serving device.

13. The system of claim 1, wherein the first portion of the media content is not related to at least one of a product and service being dispensed via the advertisement serving device.

14. The system of claim 1, wherein the advertisement serving device comprises:
a user interface to conduct commerce.

15. The system of claim 14, wherein:
the processor is further configured to select a product based at least in part on the business rules received from the control server; and
the user interface is configured to dispense the selected product to a consumer.

16. The system of claim 14, wherein conducting commerce includes at least one of product vending, selling merchandise, selling tickets, dispensing money, conducting financial transactions, providing a service and dispensing information.

17. The system in claim 14, wherein the user interface to conduct commerce includes:
an interface component for receiving a product selection from the consumer;
a payment interface component for processing payment from the consumer; and
a dispensing component for dispensing the selected product to the consumer.

18. An advertisement serving device comprising:
a network interface for receiving targeted advertising rules and a set of advertising content from a control server via a communications network;
a memory configured to store the targeted advertising rules and the set of advertising content;
a processor configured to select an advertisement from the set of advertising content in the memory based on the targeted advertising rules; and
a display configured to display the selected advertisement.

19. The device of claim 18, wherein the targeted advertising rules comprise rules for selecting advertising content based at least in part on the geographic location of the advertisement serving device.

20. The device of claim 18, wherein the targeted advertising rules comprise rules for selecting advertising content based at least in part on a business located within the geographical area of the advertisement serving device.

21. The device of claim 18, wherein the targeted advertising rules comprise rules for selecting the advertisement content based on at least one of the time of day, day in the week, day in the year, season, holidays, retail sales periods, and cultural events.

22. The device of claim 18, wherein the targeted advertising rules include rules for a sequence of a plurality of advertising content to be displayed.

23. The device of claim 18, further comprising:
a dispensing component configured to make products available to a consumer for purchase.

24. A distributed system of advertisement serving devices comprising:
a first advertisement serving device, wherein the first advertisement serving device is configured to:
store business rules and a plurality of advertisements in a first memory;
select a first advertisement from the plurality of advertisements based at least in part on the business rules stored on the first memory; and
display the selected advertisement on a display screen of the first advertisement serving device;
a second advertisement serving device located in a different location from the first advertisement serving device, wherein the second advertisement serving device is configured to:
store business rules and a plurality of advertisements in a second memory;
select a second advertisement from the plurality of advertisements based at least in part on the business rules stored on the second memory; and
display the selected advertisement on a display screen of a second advertisement serving device;
a control server configured to load media content and business rules onto the first memory of the first advertisement serving device and the second memory of the second advertisement serving device via a network.

25. The distributed system of claim 24 further comprising an off-network advertisement serving device configured to:
receive manual loading of advertisement content and business rules onto a third memory in the off-network advertisement serving device;
store the advertisement content and business rules locally on the third memory; and
operate in stand-alone mode by selecting an advertisement from the third memory based at least in part on the business rules stored in the third memory.

26. The distributed system of claim 24, wherein the business rules on the first and second memories of the advertisement serving devices comprise rules for selecting advertisements based on the relative locations of the advertisement serving devices.
